(19) United States
(12) Patent Application Publication
(10) Pub. No.: US 2009/0084887 A1
(43) Pub. Date: Apr. 2, 2009

(54) MOLDED MODULAR CABLE DUNNAGE SYSTEM

(76) Inventors: Christopher J. Aiston, Nashua, NH (US); Chi Lam (Jonathan) Yau, Dover, NH (US); Joseph A. Hoell, Dunbaston, NH (US)

Correspondence Address: Jennifer Lacroix;DLA PIPER US LLP, Suite 1900, 203 N. LaSalle St., Chicago, IL, 60601, US

(21) Appl. No.: 12/036,420

(22) Filed: Feb. 25, 2008

Related U.S. Application Data
(63) Continuation-in-part of application No. 11/279,424, filed on Apr. 12, 2006, now abandoned.
(60) Provisional application No. 60/671,845, filed on Apr. 15, 2005.

(51) Int. Cl. B65H 75/14; B23P 11/00

(52) U.S. Cl. 242/587.2; 242/118.4; 29/428; 242/609.1

(57) ABSTRACT

A modular dunnage system for the transportation, storage and dispensation of electrical wire and cable. Embodiments of modular cable dunnage system generally comprise at least two flange portions and at least two hub portions. In some embodiments, the system has two reel-hub halves that each comprise a flange portion and a hub portion. In other embodiments, the system has two flange portions and two or more hub portions that interlock and connect with the flange portions.

### RELATED APPLICATIONS

This application is a continuation-in-part of U.S. patent application Ser. No. 11/279,424, filed on Apr. 12, 2006, currently pending, which claims the benefit of U.S. Provisional Patent Application Ser. No. 60/671,845, filed Apr. 15, 2005, now abandoned, the disclosures of which are hereby incorporated by reference in their entirety.

### BACKGROUND

The present invention finds use in the field of electrical wire and cable. More particularly, the present invention relates to systems for packaging, handling, shipping and storage of electrical wire and cable.

The packaging, transportation, handling and storage of bulk quantities of thick filamentous materials, such as cable, wire, and rope, have always presented special challenges to their respective manufacturers and end users. Long strands of filamentous materials must be handled in a particular fashion to facilitate use and distribution while, at the same time, protecting the product from damage. By their very nature, such materials can become entwined upon themselves, therefore wasting valuable time and resources to untangle, and potentially damaging the materials. Further, such materials are unwieldy to handle, transport, store and dispense without the use of traditional spools or reels.

Conventionally, cable, wire and other filamentous materials are wound upon a spool or reel at the end of the manufacturing process. Such reels are well known in the art and are generally comprised of wood, plastic, or steel, depending on the type of material spooled thereon, designated application, or customer preference. The wire or cable is usually spooled upon such reels at a designated length that is known to fit on the particular reel size used, although a visual determination of when the reel is full can be made. The entire filled reel is removed from the uptake apparatus, the material secured to the reel and shipped to the customer or stored for later shipment.

Upon receipt by the customer, the filamentous material is used either as is, on the reel, or unspooled from the reel to a second uptake reel that is part of the customer's on-site equipment. In either situation, once the wire or cable is unspooled, the customer is left with an empty reel. This presents a problem as typical reels are bulky and thus occupy a great deal of storage space. The customer may ship the empty reel back to the manufacturer, but this encompasses extra costs, exacerbated by the bulky size and shape of conventional reels. The empty reel can be destroyed or recycled, but again some party must bear the costs of shipping and transportation and thus may not be an efficient use of resources. Further, typical spool materials are not easily recyclable or reusable. For example, typical prior art wood spools splinter after only a few uses, thus causing damage to the materials coiled thereon. Further, typically spool materials tend to age quickly when left outdoors for a period of time. Once such materials begin to age, the product is easily damages during handling.

One obvious solution is to ship the wound cable or wire to an end-user without a reel. However, because of the rigors of shipping and storage, cable, wire and similar products are subject to damage. Another solution embodied in U.S. Pat. No. 6,045,087 to Vislocky, et al. is the use of a spool which breaks down into separate components after use. The spool assembly comprises a spindle formed as a tubular section and two end flanges. Two piece breakdown spools are described in U.S. Pat. Nos. 6,102,327 to Ripplinger and 4,903,913 to McCaffrey. While these devices appear to solve the problems associated with storage of empty reels, the end-user still must transport all of components back to the cable producer. Even in a disassembled state, the constituent components are bulky and do not generally collapse into smaller packages for transport. Finally, many molded plastic prior art systems require two large molding tools to create the respective halves of the spool.

### BRIEF SUMMARY

The present invention generally relates to systems for packaging, handling, shipping and storage of electrical wire and cable. Preferred embodiments of the present invention provide modular cable dunnage systems having two flange portions and at least two hub portions.

In one aspect, modular dunnage systems of the present invention comprise a first reel-hub half and a second reel-hub half, a hollow bolt inserted through the central aperture of each reel-hub portion when the reel-hub halves are assembled, and a fixture removably secured to the second end of the hollow bolt. Each reel-hub half preferably has a flange portion, a hub portion having a terminal end and a flange end, and a central aperture. The terminal end of each hub portion has connection features that matingly join the connection features of the terminal end of the other hub portion when the two reel-hub halves are assembled. The hollow bolt preferably has a first end and a second end, and a stop is connected to the first end of the hollow bolt.

In another aspect, modular dunnage systems of the present invention comprise a first reel-hub half and a second reel-hub half, each reel-hub half having a flange portion, and a hub portion having a terminal end and a flange end, the terminal end of each hub portion having an outer edge having a circumference. The terminal end of each hub portion comprises a plurality of raised teeth spaced around the terminal end of the hub portion and a plurality of receiving slots, each of the raised teeth having a width at the outer edge that is approximately equal to circumference divided by the total number of raised teeth plus receiving slots on one of the reel-hub halves.

In a third aspect, methods for assembling modular dunnage systems are provided. Preferably, such methods include the steps of providing a hollow bolt having a first end and a second end, wherein a stop is connected to the first end of the hollow bolt, and orienting the hollow bolt vertically with the stop facing down; providing a first reel-hub half and a second reel-hub half, each reel-hub half having a flange portion, a hub portion having a flange end and a terminal end, and a central aperture; placing the first reel-hub half over the hollow bolt, the first reel-hub half being oriented with the flange portion down, and the hollow bolt extending through the central aperture of the first reel-hub half; placing the second reel-hub half over the hollow bolt, the second reel-hub half being oriented with the hub portion down, and the hollow bolt extending through the central aperture; matingly joining the first and second reel-hub halves; applying a compression load to the second reel-hub half; and removably securing a fixture to the second end of the hollow bolt.

As used herein, the term “electrical wire” shall refer to both electrical wire and cable, unless otherwise indicated.

### BRIEF DESCRIPTION OF SEVERAL VIEWS OF THE DRAWINGS

Preferred embodiments of modular dunnage systems of the present invention are shown in the accompanying drawings.

FIG. 1 provides a perspective view of a first embodiment of a modular cable dunnage system of the present invention.

FIG. 2 provides a side elevational view of the embodiment illustrated in FIG. 1.

FIG. 3 provides a top plan view of the embodiment illustrated in FIGS. 1-2.

FIG. 4 provides an elevational view of the embodiment illustrated in FIGS. 1-3, as collapsed for transportation and storage.

FIG. 5 provides an exploded view of the embodiment illustrated in FIGS. 1-4.

FIG. 6 illustrates a perspective view of a second embodiment of a modular cable dunnage system of the present invention.

FIG. 7 illustrates a side elevational view of the embodiment illustrated in FIG. 6.

FIG. 8 illustrates a top plan view of the embodiment illustrated in FIGS. 6-7.

FIG. 9 illustrates an exploded view of the embodiment illustrated in FIGS. 6-8.

FIG. 10 provides a perspective view of a third embodiment of a modular cable dunnage system of the present invention.

FIG. 11 provides a side elevational view of the embodiment illustrated in FIG. 10.

FIG. 12 provides a top plan view of the embodiment illustrated in FIGS. 10-11.

FIG. 13 provides an exploded view of the embodiment illustrated in FIGS. 10-12.

FIG. 14 provides an elevational view of the embodiment illustrated in FIGS. 10-13, as disassembled for storage or transportation.

FIG. 15 provides an exploded view of a fourth embodiment of a modular cable dunnage system of the present invention.

FIG. 16 provides a side elevational view of a fifth embodiment of a modular cable dunnage system of the present invention.

FIG. 17 provides a perspective view of a sixth embodiment of a modular cable dunnage system of the present invention.

FIG. 18 provides an exploded view of the embodiment of FIG. 17.

### DETAILED DESCRIPTION

The present invention generally relates to molded cable storage and transportation assemblies. More particularly, the present invention relates to modular cable dunnage systems having two or more component parts that can be connected to form the modular dunnage system. In preferred embodiments, such assemblies are symmetrical about the centerline of the assembled modular cable dunnage system.

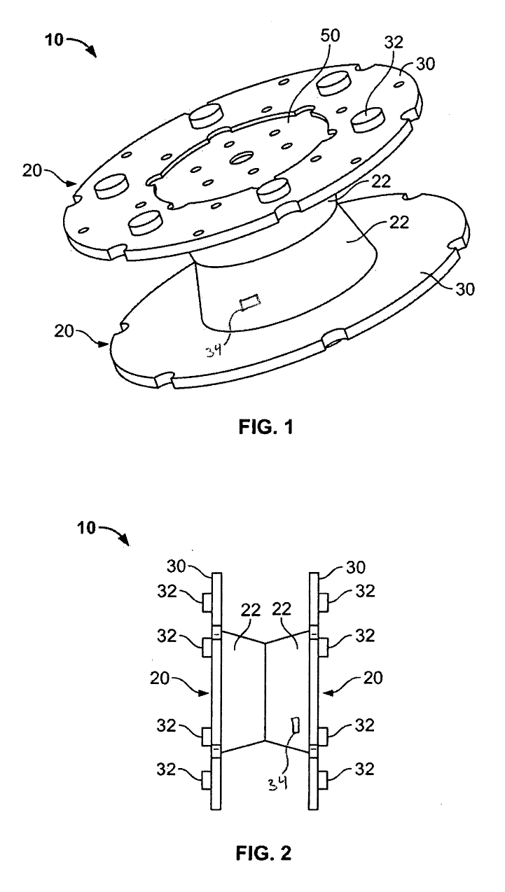

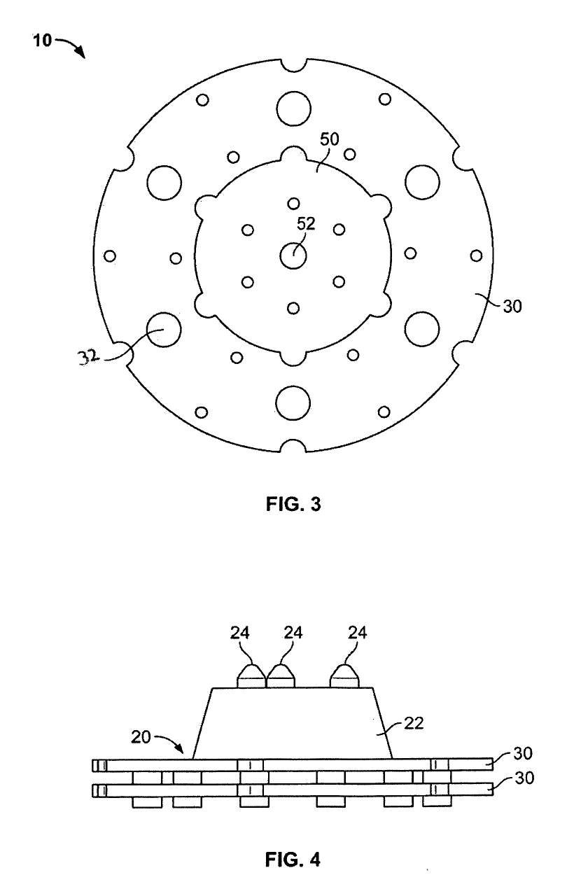

A first embodiment of the present invention is illustrated in FIGS. 1-5. In general, modular cable dunnage system 10 is a large, molded, two-part assembly that is symmetrical about the centerline. The assembly has first and second reel-hub halves 20. Each reel-hub half 20 of the assembly is formed from a single molded piece having a central, tapered, hub 22 that terminates with a flange 30. The tapered hub 22 allows easy insertion into a raw coil bundle for use by an end-user to unload the electrical wire and thus further allows the wire to be shipped with no reel attached. The terminal end of each hub contains a plurality of raised fittings or pins 24 and an equal plurality of apertures 26. Preferably, the fittings 24 and apertures 26 alternate in position to as to provide a self-aligning and interlocking structure when assembling the first and second reel-hub halves 20 together. The terminal end of each hub 22 preferably also has at least one bolt hole 36, by which the first and second reel-hub halves 20 can be secured together using conventional fasteners, preferably screws or threaded bolts.

Modular cable dunnage system 10 also features two adapters 50, one for each end of the dunnage system 10. The first adapter 50 attaches to the first reel-hub half 20, and the second adapter 50 attaches to the second reel-hub half 20. Preferably, conventional fasteners 40, such as screws or threaded bolts, can be used to secure each of the adapters 50. Each adaptor 50 has central apertures 52, which is preferably sized to mount on the end user's equipment. Accordingly, when the electrical wire is depleted from modular cable dunnage system 10 of this embodiment, after removal of the adaptors 50, the two reel-hub halves 20 can be separated from each others and can be either shipped back to the electrical wire manufacturer or stored.

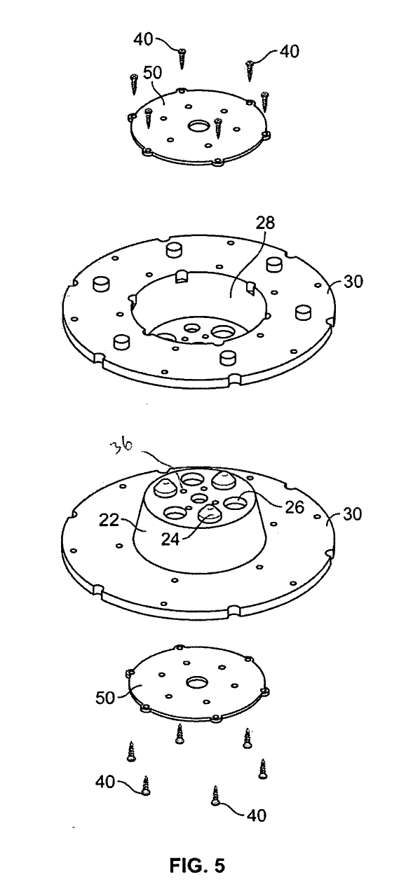

As shown in FIGS. 4-5, the reel-hub halves 20 can be constructed with a central hollow aperture 28 so that the two reel-hub halves 20 (or multiple halves) can nest together during shipping and/or storage. In some embodiments, the respective reel-hub halves 20 of the modular cable dunnage system 10 can be formed with a slot 34 in the hub portion 22 that allows for the cable/wire tail to be inserted into the central hollow aperture 28. The tail is therefore protected during shipping, installation and storage and does not have to be attached to the flange 30, as is seen in prior art reels. In other embodiments, an attachment for the ends or tails of the cable can be provided on at least one of the reel-hub halves 20, such as on a flange portion 30, to eliminate the need to use staples, rope or other means of tying the ends of the cable in place prior to shipping or storage. Each reel-hub half 20 is also preferably formed with integral standoffs 32, to allow a fork truck driver to pick up the parts while the center axis is vertical as well as horizontal.

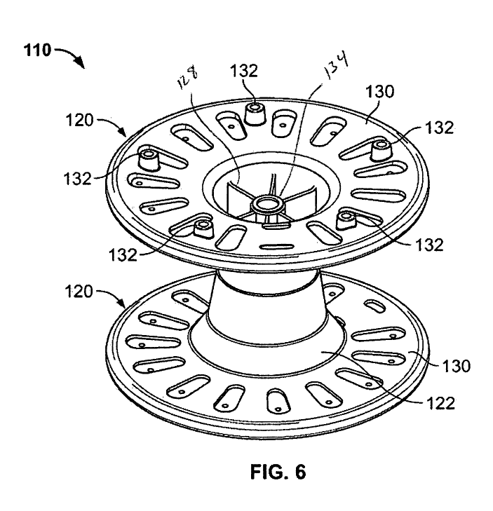

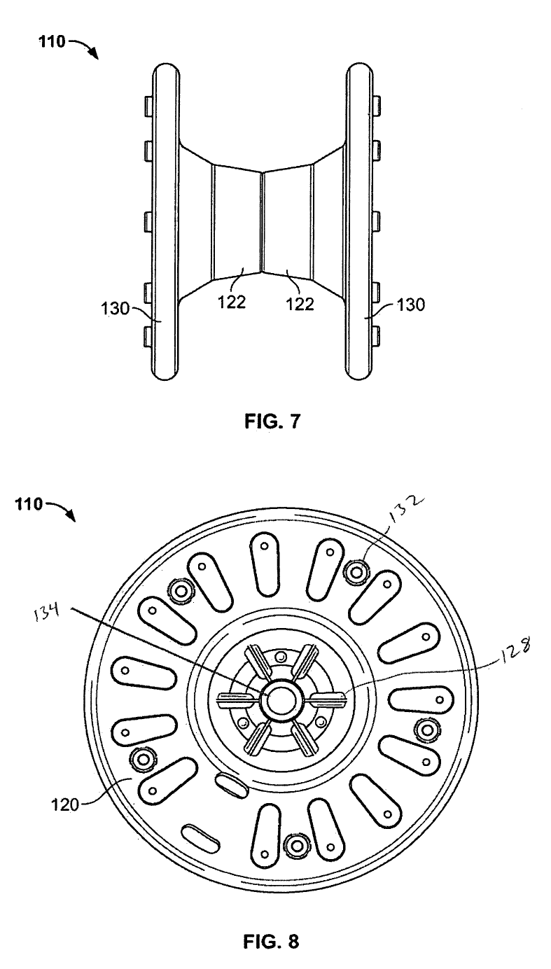

As shown in FIGS. 6-9, modular cable dunnage system 110 is similar to modular cable dunnage system 110. Modular cable dunnage system 110 is generally formed by a large, molded, two-part assembly that is symmetrical about the centerline. The assembly has first and second reel-hub halves 120. Each reel-hub half 120 of the assembly 110 is formed from a single piece having a central, tapered, hub 122 that terminates with a flange 130. Also, each reel-hub half 120 contains a plurality of raised fittings or pins 124 and an equal plurality of apertures or detents 126 located at the terminal end of the hub portion 122. Preferably, the fittings 124 and apertures 126 alternate in position to as to provide a self-aligning and interlocking structure when assembling the two reel-hub halves 120 together.

Preferably, each reel-hub half 120 has support gussets 128 extending radially from the central aperture 134, to provide increased structural integrity. At least one of the reel-hub halves 120 can be formed with a slot (not shown) in the hub portion 122, that insertably receives the tail end of an electrical cable or wire into the hub portion, preferably into a hollow section between support gussets 128. The tail can therefore protected during shipping, installation and storage and does not have to be attached to the flange 130. Alternatively, an attachment for the ends or tails of the cable can be provided on at least one of the reel-hub halves 120, such as on a flange portion 130, to eliminate the need to use staples, rope or other means of tying the ends of the cable in place prior to shipping or storage. Each reel-hub half 120 is also preferably formed with integral standoffs 132, to allow a fork truck driver to pick up the parts while the center axis is vertical as well as horizontal.

Central aperture 134 of each reel-hub half 120 extends through the center of the reel-hub half 120, including through the flange portion 130 and the hub portion 120. The first and second reel-hub halves 120 can be assembled by aligning the raised fittings and apertures of each reel-hub half with those of the other reel-hub half, and then inserting a single large hollow bolt 142 through the central apertures 134 of both reel-hub halves. Nuts 144, along with washers 146, can be secured to the first and second ends of the hollow bolt 142, to secure the two reel-hub halves together. Hollow bolt 142 can act as a spindle interface with the end user's unspooling equipment.

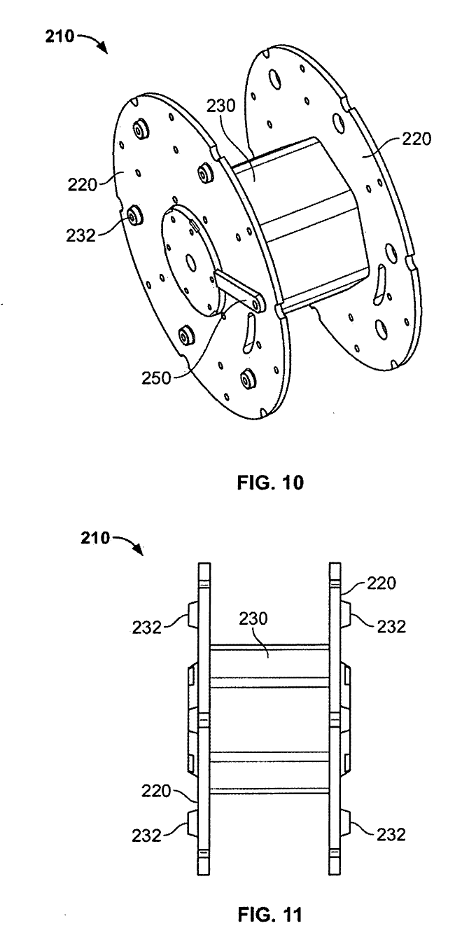

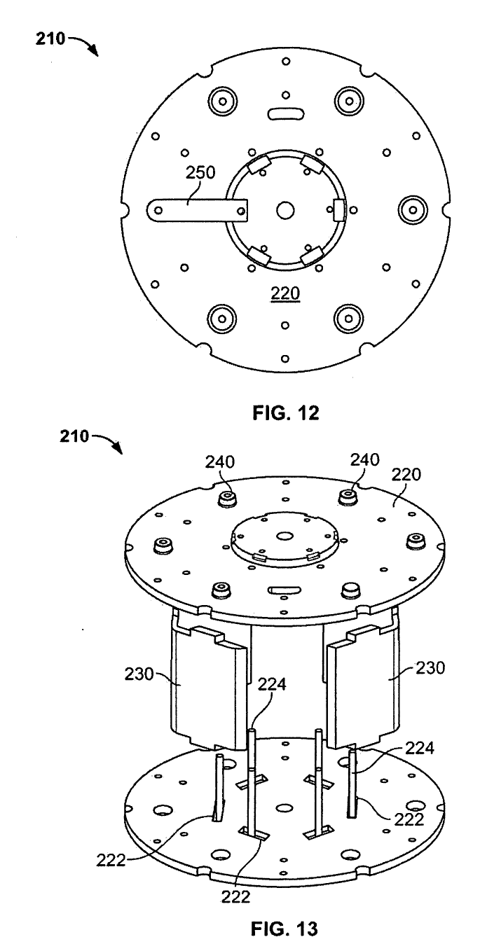

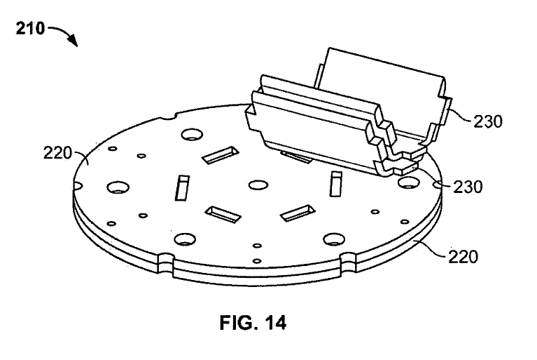

A third modular cable dunnage system embodiment is illustrated in FIGS. 10 through 14. In this embodiment, modular cable dunnage system 210 is generally comprised of two molded flanges 220 and two drum or hub portions 230. Each flange 220 has multiple slots 222 and the drum portions 230 are configured to mount into slots 222, such as through a plurality of complimentary slats formed on each drum portion 230. each drum portion is preferably internally supported by a plurality of rods 224 that are also mounted to the flanges 220. Conventional bolts 240 can be used to secure the drum portions 230 and the rods 224 to the flanges. A tail bar 250 can be provided on the outside of at least one of the flanges 220 to secure the cable tail (not shown) to the flange 220. The molded parts of modular cable dunnage system 210 are designed to nest together for shipment and storage, as shown in FIG. 14.

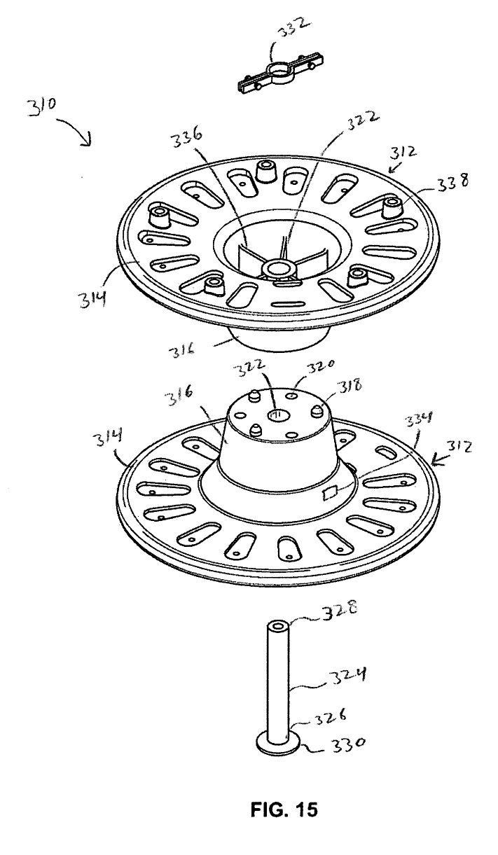

A fourth embodiment of a modular cable dunnage system 310 of the present invention is illustrated in FIG. 15. Modular cable dunnage system 310 has two reel-hub halves 312. Each reel-hub half 312 has a flange portion 314 and a hub portion 316. The hub portion 316 of each reel-hub half 312 has a flange end and a terminal end, and is preferably tapered such that the diameter of the hub portion 316 is the greatest at the flange end, near the flange portion 314, and decreases towards the terminal end. A tapered hub portion allows easy insertion into a raw coil bundle for use by an end-user to unload the electrical wire and thus further allows the wire to be shipped with no reel attached. Preferably, each reel-hub half 312 has support gussets 334 extending radially from the central aperture 322, to provide increased structural integrity. At least one of the reel-hub halves 312 can be formed with a slot 334 in the hub portion 316, that insertably receives the tail end of an electrical cable or wire into the hub portion, preferably into a hollow section between support gussets 336. The tail can therefore protected during shipping, installation and storage and does not have to be attached to the flange 314. Each reel-hub half 312 also has a central aperture 322 that extends through the center of the reel-hub half 312, including through the flange portion 314 and the hub portion 316. Each reel-hub half 312 can also be formed with integral standoffs 338, to allow a fork truck driver to pick up the parts while the center axis is vertical as well as horizontal.

Each reel-hub half 312 is preferably formed from a single molded piece, and the first reel-hub half is preferably identical to the second reel-hub half 312. In such systems, both reel-hub halves 312 can preferably be formed using a single mold, and the assembled cable dunnage system is symmetrical about the center line.

As shown in FIG. 15, the terminal end of each hub portion 316 has a plurality of connection features that matingly join the connection features of the terminal end of the other hub portion when the two reel-hub halves are assembled. As illustrated in FIG. 15, the terminal end of each hub portion 316 has a plurality of raised fittings or pins 318, and an equal plurality of apertures 320. Preferably, the fittings 318 and apertures 320 alternate in position around the terminal end of each reel-hub half 312, and thus provide a self-aligning and interlocking structure when assembling the two reel-hub halves 312.

In preferred embodiments of modular cable dunnage systems, the component parts are assembled in a manner that provides compression loading between the parts. Such compression loading assists in keeping the component parts together while cable is being wound onto the hub portions of the system, and also assists in holding the component parts together during shipping, handling, and the unwinding of the cable from the system. As illustrated in FIG. 15, the first and second reel-hub halves 312 are assembled by aligning the fittings 318 and apertures 320 of the first reel-hub half with the apertures 320 and fittings 318 of the second reel-hub half, respectively, and connecting the two reel hub halves 312 by inserting a hollow bolt 324 through the central aperture 322 of each reel-hub half 312. Hollow bolt 324 has a first end 326 and a second end 328, and can be an axel or pipe. First end 326 of hollow bolt 324 has stop 330 connected thereto, such as, for example, by being welded thereto. Preferably, stop 330 is a flat round washer having an inner diameter that receives the hollow bolt 324 and an outer diameter that is larger than the diameter of the central aperture 320 of the reel-hub halves 312. Second end 328 of the hollow bolt 324 can be threaded. While a hollow bolt is illustrated, and preferred, a solid bolt may be used instead of a hollow bolt 324.

In one method of assembling cable dunnage system 310, the hollow bolt 324 is placed vertically, with stop 330 at the bottom, and second end 328 at the top. The first reel-hub half 312 is placed over hollow bolt 324, with flange portion 314 down, hub portion 316 up, and hollow bolt 324 extending through the central aperture 322. The second reel-hub half 312 is placed over hollow bolt 324, with hub portion 316 down, flange portion 314 up, and hollow bolt 324 extending through the central aperture 322. The connection features of the first and second reel-hub halves are aligned, and the two reel-hub halves are thus matingly joined. As illustrated in FIG. 15, the connection features are a plurality of raised fittings 318 and apertures 320 on the terminal end of each hub portion. A compression load is then applied to the top of second reel-hub half 312. The compression load can be applied in any suitable manner, such as, for example, by a large H frame vertical press. Once the compression load is at the desired level, a fixture 332 is removably secured to the second end 328 of the hollow bolt 324. Fixture 332 is preferably a steel spring clamp, although other suitable devices can be used, such as, for example, other types of clamps or nuts. In this method, the hollow bolt 324 and the fixture 332 retain the compression load, but are not required to produce the compression load.

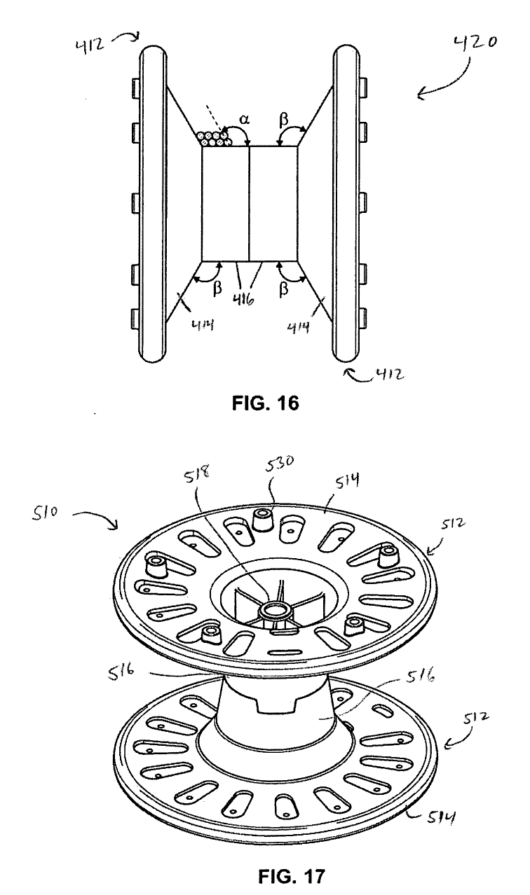

Modular cable dunnage systems of the present invention, such as, for example, the embodiments described above, can have alternative configurations. For example, when winding a cable onto a modular dunnage system, an optimum utilization of space, or optimum fill, can be achieved when each wind of the cable nests in alignment with the other winds of the cable. As illustrated in FIG. 16, when each wind of the cable nests in alignment with the other winds of the cable, a nesting angle α is formed between the center points of the cable windings and the surface of the hub portion onto which the cable is being wound. Reel-hub halves of the present invention can have any angle between the flange portion and the hub portion. In the embodiment illustrated in FIG. 16, each reel-hub half 412 of cable dunnage system 410 has a flange portion 414 and hub portion 416. Flange portion 414 is illustrated as being tapered and hub portion 416 is illustrated as being straight, or horizontal with respect to the ground when the modular dunnage system is horizontal. Hub portion 416 can be straight or tapered. Preferably, as shown in FIG. 16, tapered portion 414 and hub portion 416 form an angle β, which is equal to angle α, the nesting angle. In at least some embodiments, flange portion 414 and hub portion 416 form an angle of about 120° with respect to each other. Without being bound by any particular theory, it is believed that having the flange portion and the hub portion form an angle equal to the nesting angle, the cable will more naturally fall into optimum position during winding. The benefits that may be realized in such embodiments include increased efficiency and speed during the winding process, optimized fill resulting in more cable fitting into a package, and minimization of tangling when cable is unwound from the package.

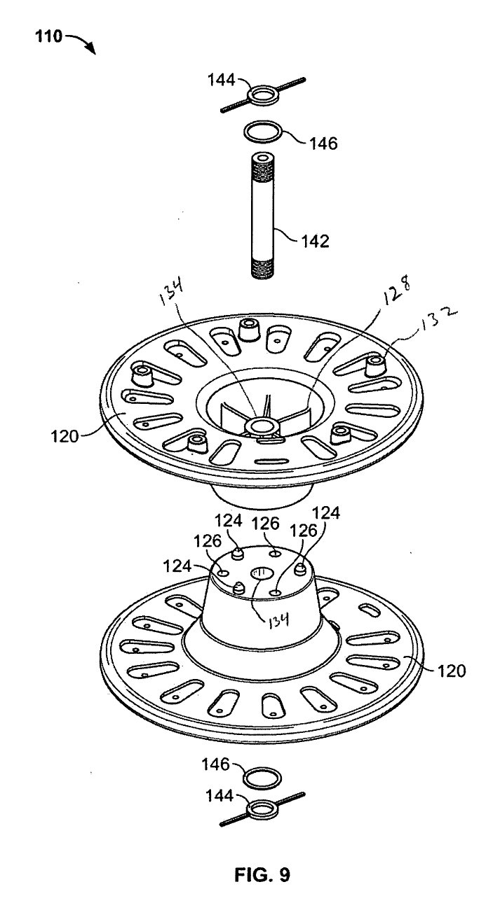

Another example of an alternative configuration for reel-hub halves of the present invention relates to the connection features on the terminal end of each hub portion. The connection features can have any suitable shape, or set of corresponding shapes. For example, as illustrated in FIG. 5, for example, the connection features are a plurality of raised fittings 24 and apertures 26, which each have a circular base cross section at the surface of the terminal end of the flange portion. The diameter of each raised fitting and each aperture is less than the radius of the terminal end surface of the hub portion. Each fitting and aperture in FIGS. 5 and 9 has a shape that is generally cylindrical at the base and transitions to a generally rounded conical shape at the tip.

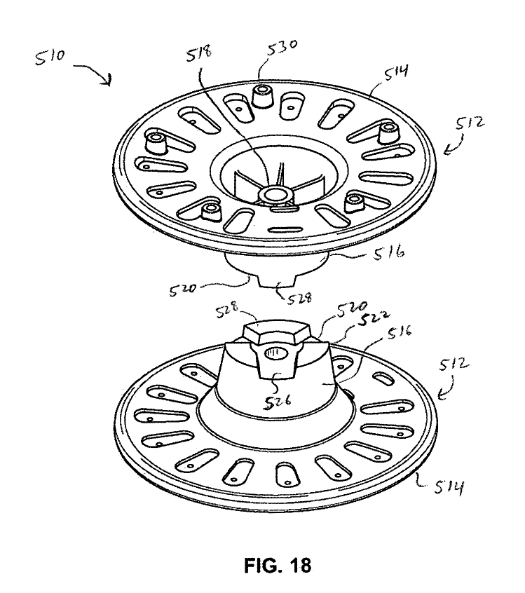

It is preferred that the connection features be configured to promote and maintain the connection between the two reel-hub halves during winding, storage and shipment of the cable dunnage system. It has been found that when the cable being wound is small, or when cables are wound under tension, the cable can exert force at the spilt between two reel-hub halves, and such force tends to push the two reel-hub halves away from each other. The cable dunnage system 510 illustrated in FIGS. 17 and 18, has two reel-hub halves 512. Each reel-hub half 512 has flange portion 514, hub portion 516, and central aperture 518. Each hub portion 516 has terminal end 520. Central aperture 518 extends through reel-hub half 512, passing through the center points of both flange portion 514 and the hub portion 516, and has a diameter less than the diameter of terminal end 520 of the hub portion 516. In some embodiments, central aperture 518 can receive a hollow bolt, such as, for example, those shown in FIG. 9 or 15. In other embodiments, central aperture 518 is not present. In some such embodiments, there are fastener holes in terminal end 520 through which fasteners can be secured to connect the first and second reel-hub halves.

Terminal end 520 has an outer edge 522 having a circumference, and an inner edge 524 having a diameter 532 that is the diameter of central aperture 518. The surface length of terminal end 520 can be measured from the outer edge 522 to the inner edge 524. Terminal end 520 also has a plurality of raised teeth 528 spaced around the terminal end of the hub portion. Because each of the spaced teeth 528 is raised from the surface of the terminal end 520, a plurality of receiving slots 526 is present between the teeth 528. Each of the spaced raised teeth 528 has a length that is less than or equal to the surface length of terminal end 520. Additionally, it is preferred that each of the raised teeth 528 have a width at outer edge 522 that is approximately equal to circumference divided by the total number of raised teeth 528 plus receiving slots 526 on one of the reel-hub halves 512. For example, FIGS. 17 and 18 show three raised teeth 528, and three receiving slots 526 on each reel-hub half 512. Therefore, the width of each of the raised teeth 528 at outer edge 522 is preferably about one sixth of the circumference of outer edge 522. The raised teeth 528 of the first reel-hub half 512 align with, and matingly join with, the receiving slots 528 between the raised teeth 528 of the second reel-hub half when the two reel-hub halves 512 are assembled, resulting in an interlocking configuration between the outer edges 522 of the terminal ends 520 of the two reel-hub halves 512. Although not being bound by any particular theory, it is believed that an interlocking configuration between the outer edges of the terminal ends of the two reel-hub halves serves to prevent the cable from getting caught or forced into the split between the two reel-hub halves, and thus assists in maintaining the connection between the two reel-hub halves.

Additional features that can be incorporated into embodiments of modular cable dunnage systems of the present invention. For example, a flat portion can be integrated in the packaged cable in order to eliminate the need for chocks or blocks to prevent rolling. Further, The molded reel-hub halves are preferably made from materials with good weathering properties and are environmentally stable and tough enough to withstand multiple uses.

Modular cable dunnage systems of the present invention can provide several benefits including, for example, they are preferably designed to be stored and used in both horizontal and vertical positions, as well as to facilitate the handling, simplify the loading, and maximize the number of pieces per truck load, thereby reducing both labor costs and freight charges within the customer's field of operations or between the cable manufacturing plant and the end user. Additionally, embodiments of modular cable dunnage systems of the present invention can preferably be used many times in the supply chain. Such ability to re-use the invention eliminates the need for a plurality of parts that would otherwise be required with expensive one or two use packages.

From the foregoing, it will be appreciated that although specific embodiments of the invention have been described herein for purposes of illustration, various modifications may be made without deviating from the spirit or scope of the invention. It is therefore intended that the foregoing detailed description be regarded as illustrative rather than limiting, and that it be understood that it is the following claims, including all equivalents, that are intended to particularly point out and distinctly claim the subject matter regarded as the invention.

We claim:

1. A modular dunnage system for electrical cable and wire, the system comprising:
a first reel-hub half and a second reel-hub half, each reel-hub half having a flange portion, a hub portion having a terminal end and a flange end, and a central aperture, wherein the terminal end of each hub portion has connection features that matingly join the connection features of the terminal end of the other hub portion when the two reel-hub halves are assembled;
a bolt inserted through the central aperture of each reel-hub portion when the reel-hub halves are assembled, the hollow bolt having a first end and a second end, wherein a stop is connected to the first end of the hollow bolt; and
a fixture removably secured to the second end of the hollow bolt.

2. The modular dunnage system of claim 1, wherein the connection features of each reel-hub half comprise a plurality of raised fittings and a plurality of apertures to receive the fittings from the other hub portion.

3. The modular dunnage system of claim 2, wherein the plurality of raised fittings and the plurality of apertures alternate in position around the terminal end of each reel-hub half.

4. The modular dunnage system of claim 1, wherein the connection features of each reel-hub half comprise a plurality of raised teeth spaced around the terminal end of the hub portion.

5. The modular dunnage system of claim 4, wherein the connection features of each reel-hub half further comprise a plurality of receiving slots spaced around the terminal end of the hub portion that receive the raised teeth of the other reel-hub half.

6. The modular dunnage system of claim 1, wherein the bolt is a hollow bolt.

7. The modular dunnage system of claim 1, wherein at least one of the reel-hub halves has a slot that insertably receives a tail end of an electrical cable or wire into the hub portion.

8. The modular dunnage system of claim 1, wherein each reel-hub half has a tapered hub portion.

9. The modular dunnage system of claim 1, wherein the stop is integrally connected to the hollow bolt.

10. The modular dunnage system of claim 9, wherein the stop is a washer that is welded to the hollow bolt.

11. The modular dunnage system of claim 1, wherein the fixture is a steel spring clamp.

12. The modular dunnage system of claim 1, wherein the flange portion and the hub portion form an angle that is equal to a nesting angle formed by an electrical cable or wire that is sound onto the modular dunnage system.

13. The modular dunnage system of claim 1, wherein the flange portion and the hub portion form an angle of about 120° with respect to each other.

14. A method of assembling a modular dunnage system having a compression load, the method comprising the steps of:
providing a bolt having a first end and a second end, wherein a stop is connected to the first end of the bolt, and orienting the bolt vertically with the stop facing down;
providing a first reel-hub half and a second reel-hub half, each reel-hub half having a flange portion, a hub portion having a flange end and a terminal end, and a central aperture;
placing the first reel-hub half over the bolt, the first reel-hub half being oriented with the flange portion down, and the bolt extending through the central aperture of the first reel-hub half;
placing the second reel-hub half over the bolt, the second reel-hub half being oriented with the hub portion down, and the bolt extending through the central aperture;
matingly joining the first and second reel-hub halves;
applying a compression load to the second reel-hub half, and
removably securing a fixture to the second end of the bolt.

15. The method of claim 14, wherein the bolt is a hollow bolt.

16. The method of claim 14, wherein the terminal end of each hub portion comprises connection features, and the step of matingly joining the first and second reel-hub halves comprises aligning the connection features of the first reel-hub half with the connection features of the second reel-hub half.

17. The method of claim 16, wherein the connection features comprise a plurality of raised fittings and a plurality of apertures.

18. The method of claim 16, wherein the connection features comprise a plurality of raised teeth spaced around the terminal end of the hub portion.

19. A modular dunnage system for electrical cable and wire, the system comprising:
a first reel-hub half and a second reel-hub half, each reel-hub half having a flange portion, and a hub portion having a terminal end and a flange end, the terminal end of each hub portion having an outer edge having a circumference;
wherein the terminal end of each hub portion comprises a plurality of raised teeth spaced around the terminal end of the hub portion and a plurality of receiving slots, each of the raised teeth having a width at the outer edge that is approximately equal to circumference divided by the total number of raised teeth plus receiving slots on one of the reel-hub halves.

20. The modular dunnage system of claim 16, wherein each reel-hub half further comprises a central aperture that extends through the flange portion and hub portion.

21. The modular dunnage system of claim 17, further comprising:
a bolt inserted through the central aperture of each reel-hub portion when the reel-hub halves are assembled, the bolt having a first end and a second end, wherein a stop is connected to the first end of the bolt; and
a fixture removably secured to the second end of the bolt.

22. The modular dunnage system of claim 21, wherein the stop is integrally connected to the hollow bolt.

23. The modular dunnage system of claim 19, wherein the flange portion and the hub portion form an angle that is equal to a nesting angle formed by an electrical cable or wire that is sound onto the modular dunnage system.

24. The modular dunnage system of claim 19, wherein the bolt is a hollow bolt.
